(19) United States
(12) Patent Application Publication
(10) Pub. No.: US 2017/0015599 A1
(43) Pub. Date: Jan. 19, 2017

(54) METHOD AND APPARATUS FOR OXIDATION OF TWO-DIMENSIONAL MATERIALS

(71) Applicant: NOKIA TECHNOLOGIES OY, Espoo (FI)

(72) Inventors: Alexander Alexandrovich BESSONOV, Moscow (RU); Marina Nikolaevna KIRIKOVA, Moscow (RU); Dmitrii Igorevich PETUKHOV, Perm (RU)

(21) Appl. No.: 15/121,020

(22) PCT Filed: Feb. 28, 2014
(86) PCT No.: PCT/RU2014/000133

§ 371 Date: Aug. 23, 2016

(51) Int. Cl. C04B 41/00; C04B 35/547; C04B 35/583; C03C 17/27; C04B 35/58; C04B 41/80; C03C 17/22; C04B 35/515; C04B 35/581

(52) U.S. Cl. CPC C04B 41/0045; C04B 35/5154; C04B 35/547; C04B 35/583; C04B 35/581; C04B 35/58; C04B 41/009; C04B 41/80; C03C 17/225; C03C 17/27; C04B 2235/663

(57) ABSTRACT

In accordance with an example embodiment of the present invention, a method is disclosed. The method comprises providing a two-dimensional object comprising a lll-V group material, e.g. Boron nitride (BN), Boron carbon nitride (BCN), Aluminium nitride (AIN), Gallium nitride (GaN), Indium Nitride (InN), Indium phosphide (InP), Indium arsenide (InAs), Boron phosphide (BP), Boron arsenide (BAs), and Gallium phosphide (GaP) and/or a Transition Metal Dichalcogenides (TMD) group material, e.g Molybdenum sulfide (MoS2), Molybdenum diselenide (MoSe2), Tungsten sulfide (WS2), Tungsten diselenide (WSe2), Niobium sulfide (NbS2), Vanadium sulfide (VS2,), and Tantalum sulfide (TaS2) into an environment comprising oxygen; and exposing at least one part of the two-dimensional object to photonic irradiation in said environment, thereby oxidizing at least part of the material of the exposed part of the two-dimensional object.

### TECHNICAL FIELD

The present application relates to oxidation of two-dimensional materials. In particular, the invention relates to photonic oxidation of III-V group materials and transition metal dichalcogenides.

### BACKGROUND

Two-dimensional (2D) materials such as boron nitride (BN) and transition metal dichalcogenides (TMD) are structurally similar to monolayer graphene. Like graphene, the 2D BN has high thermal conductivity and good mechanical strength. Also, characteristics of 2D BN include high chemical and thermal stability, and a wide band gap leading to dielectric behavior of the material. TMDs such as MoS₂, MoSe₂, WS₂, WSe₂ and many others have received significant attention due to sizable bandgaps and superior semiconductive behavior. Besides 2D single crystals, 2D thin films which consist of packed nanosheets are researched due to their unique properties and compatibility to Roll to Roll (R2R) manufacturing. Such 2D thin films can be deposited from 2D flakes dispersions via solution-processable methods.

Similarly to graphene oxide (GO), a boron-nitride oxide (BNO) can be of interest because in the near future the 2D BNO may find a lot of applications due to its unique electronic, chemical and mechanical properties. Although 2D BN structures show higher chemical stability than their carbon counterpart, recent studies indicated that slow oxidation processes take place at high temperatures. Theoretical and experimental research devoted to the oxidation process of 2D BN at the atomic level and associated electronic properties of 2D BNO is currently quite scarce. Likewise, oxidation of 2D TMDs is not widely reported in literature, however, some 2D transition metal oxides (TMO) are known in the art. Similarly to TMDs, the TMOs show interesting electronic, optical and magnetic properties.

Conventional methods of BN oxidation include thermal annealing in the oxygen atmosphere at high temperatures (over 500° C.), and plasma assistance techniques.

### SUMMARY

According to a first aspect of the present invention, a method is disclosed. The method comprises: providing a two-dimensional object comprising a III-V group material and/or a Transition Metal Dichalcogenides (TMD) group material into an environment comprising oxygen, and exposing at least one part of the two-dimensional object to photonic irradiation in said environment, thereby oxidizing at least part of the material of the exposed part of the two-dimensional object.

The method according to this aspect may be, for example, a method for oxidation of two-dimensional materials, a method for controlled oxidation of two-dimensional materials, a method for patterned oxidation of two-dimensional materials, or a method for photo-thermal oxidation of two-dimensional materials.

For the purposes of this specification, the term two-dimensional means substantially two-dimensional and comprising one or more layers of material. This means that the size of a two-dimensional object or material in two of its dimension (usually width and length) is considerably greater than its size in the third dimension (usually thickness). However, it does not refer to objects or materials in which the third dimension is non-existent. In particular, the third and smallest dimension of the two-dimensional objects or materials according to this specification may vary between 1 atomic monolayer of material which can be approximately 0.6-0.7 nanometers and 1 micrometer, while the greater two dimensions (e.g. width and length) may vary between 50 nanometers and 1 meter. An object may refer to a structure, a film, a nano flake, a combination of materials etc. The terms two-dimensional object, two-dimensional film, two-dimensional structure and two-dimensional material are widely used in the art.

By a III-V group material is meant a chemical compound comprising at least one group III (IUPAC group 13) element and at least one group V element (IUPAC group 15). By a TMD group material is meant a chemical compound comprising at least one transition metal and at least one chalcogen (a chemical element of group 16 of the periodic table). The materials which the two-dimensional object comprises may also be substantially two-dimensional.

By photonic irradiation is meant electromagnetic irradiation with any spectrum including visible, ultraviolet and infrared wavelengths. By an environment comprising oxygen is meant any environment which is at least partially transparent to photonic irradiation and comprises oxygen and/or ozone. An example of the environment comprising oxygen is air at ambient conditions.

According to the method, at least part of the material of the two-dimensional object (the part that is being exposed to the photonic irradiation) is oxidized. The oxidation may be full or partial throughout the material.

According to an embodiment of the present invention, the method further comprises: providing a substrate, and depositing a III-V group material and/or a TMD group material onto the substrate, thereby forming a two-dimensional object comprising a III-V group material and/or a Transition Metal Dichalcogenides (TMD) group material, prior to providing the two-dimensional object into an environment comprising oxygen.

In other words, according to this embodiment, a substrate is provided first, then a two-dimensional object comprising a III-V group material and/or a TMD group material is formed by deposited the material(s) on the substrate, and then the two-dimensional object is provided into an environment comprising oxygen.

According to an embodiment, the III-V group material and/or the TMD group material is deposited on a substrate by at least one of the following techniques: spray coating, spin-coating, drop-coating, thin film transfer and inkjet printing. Other deposition techniques may be used in alternative embodiments.

According to an embodiment, a plastic substrate is provided. The plastic substrate may be a flexible plastic substrate. The plastic substrate may have a melting temperature between 100 and 400° C.

According to an embodiment, a rigid glass substrate is provided.

According to an embodiment, the two-dimensional object comprises at least one of the following III-V group materials: Boron nitride (BN), Boron carbon nitride (BCN), Aluminium nitride (AlN), Gallium nitride (GaN), Indium Nitride (InN), Indium phosphide (InP), Indium arsenide (InAs), Boron phosphide (BP), Boron arsenide (BAs), and Gallium phosphide (GaP).

According to an embodiment, the two-dimensional object comprises at least one of the following TMD group materials: Molybdenum sulfide (MoS₂), Molybdenum diselenide (MoSe₂), Tungsten sulfide (WS₂), Tungsten diselenide (WSe₂), Niobium sulfide (NbS₂), Vanadium sulfide (VS₂,), and Tantalum sulfide (TaS₂). More generally, the object may comprise a variety of different TMD group materials such as WX₂, MoX₂, ScX₂, TiX₂, HfX₂, ZrX₂, VX₂, CrX₂, MnX₂, FeX₂, CoX₂, NiX₂, NbX₂, TcX₂, ReX₂, PdX₂, PtX₂, wherein X stands for S, Se, or Te.

According to an embodiment, the photonic irradiation is produced with a wavelength spectrum between 200 nanometers to 900 nanometers by a xenon flash lamp.

For the purposes of this specification, a flash lamp refers to any lamp that may produce photonic irradiation for various periods of time, including short pulses and long exposures.

According to an embodiment, at least one part of the two-dimensional object is exposed to pulsed photonic irradiation. Pulsed photonic irradiation means that irradiation may take place over extended periods of time in relatively short pulses.

According to an embodiment, the individual pulse duration is between 10 microseconds and 5 milliseconds, and the pulse frequency is between 1 Hertz and 300 Hertz.

According to an embodiment, exposing at least one part of the two-dimensional object to photonic irradiation is performed for a period of time between 1 second and 60 minutes.

According to an embodiment, at least one part of the two-dimensional object is exposed to photonic irradiation using a photomask.

The photomask may be any structure that fully or partially obstructs or blocks photonic irradiation from its source to the material of the two-dimensional object. The photomask may be, for example, applied to the two-dimensional object prior to providing it into the environment comprising Oxygen. Alternatively, a photomask may be used continuously or discontinuously during the irradiation and oxidation. Any other uses of a photomask are also implied.

According to an embodiment, at least one part of the two-dimensional object that is not covered by the photomask is selectively exposed to photonic irradiation, thereby oxidizing at least part of the material of the two-dimensional object not covered by the photomask.

In this embodiment, the photomask covers certain parts of the two-dimensional object and fully or partially blocks or obstructs the photonic irradiation of these areas. Covering a part of the 2D object in this context may mean direct application of the photomask to the two-dimensional object or using it at a distance between the two-dimensional object and the source of irradiation.

According to an embodiment, at least one part of the two-dimensional object is exposed to photonic irradiation from a source that is positioned, at a predetermined distance, on the side of the substrate on which the III-V group material and/or the TMD group material was deposited.

For example, if the material was deposited on the top of the substrate and the substrate is positioned horizontally, then the source of photonic irradiation would be positioned above the substrate according to this embodiment.

According to an aspect of the present invention, a device is disclosed. The device comprises a reactor and a flash lamp, wherein the reactor comprises an environment comprising oxygen. The device further comprises a space at least partially inside the environment for receiving a two-dimensional object comprising a III-V group material and/or a Transition Metal Dichalcogenides (TMD) group material. The flash lamp of the device is caused to irradiate at least one part of the two-dimensional object when the two-dimensional object is in the space, thus causing oxidation of at least part of the material in the irradiated part of the two-dimensional object.

The device may further comprise a photomask holder, between the flash lamp and the two-dimensional object, wherein the photomask is caused to obstruct or block at least a portion of the photonic irradiation from reaching the parts of the two-dimensional object that the photomask covers.

According to an embodiment, the device also comprises a reflector for directing the photonic irradiation of the flash lamp toward the two-dimensional object.

According to an embodiment, the device also comprises a discharge module. The discharge module provides electrical power to the flash lamp at a predetermined frequency and duration.

According to an embodiment, the flash lamp is a xenon flash lamp with an emission spectrum between 200 nanometers and 900 nanometers. According to an embodiment, the flash lamp is caused to irradiate at least one part of the two-dimensional object in pulses.

According to an embodiment, individual pulse duration is between 10 microseconds and 5 milliseconds and pulse frequency is between 1 Hertz and 300 Hertz.

According to an aspect of the present invention, an apparatus is disclosed. The apparatus comprises at least one processor; at least one memory coupled to the at least one processor, the at least one memory comprising program code instructions which, when executed by the at least one processor, cause the apparatus to perform the methods according to any of the above embodiments.

According to an aspect of the present invention, an apparatus is disclosed. The apparatus comprises means to: provide an environment comprising oxygen in a reactor, hold a two-dimensional object comprising a III-V group material and/or a Transition Metal Dichalcogenides (TMD) group material inside the reactor, expose at least one part of the two-dimensional object to photonic irradiation of the flash lamp in the reactor, and oxidize at least part of the material in the exposed at least one part of the two-dimensional object.

The apparatus may further comprise means to hold a photomask between the flash lamp and the two-dimensional object, and obstruct or block at least a portion of the photonic irradiation from reaching the parts of the two-dimensional object that the photomask covers.

### BRIEF DESCRIPTION OF THE DRAWINGS

For a more complete understanding of example embodiments of the present invention, reference is now made to the following descriptions taken in connection with the accompanying drawings in which:

FIG. 1 shows a method according to an embodiment of the present invention;

FIG. 2a is a graph of the static Water Contact Angle (WCA) against irradiation time for two-dimensional hexagonal Boron Nitride (2D h-BN);

FIG. 2b is a graph of the static Water Contact Angle (WCA) against irradiation time for 2D MoS₂;

FIG. 2c is graph of the static Water Contact Angle (WCA) against irradiation time for 2D WS₂

FIG. 3a is a graph illustrating the bandgap difference of 2D h-BN before and after oxidation;

FIG. 3b is a graph illustrating the bandgap difference of 2D MoS₂ before and after oxidation;

FIG. 4 shows an apparatus according to an embodiment of the present invention.

### DETAILED DESCRIPTION OF THE EMBODIMENTS

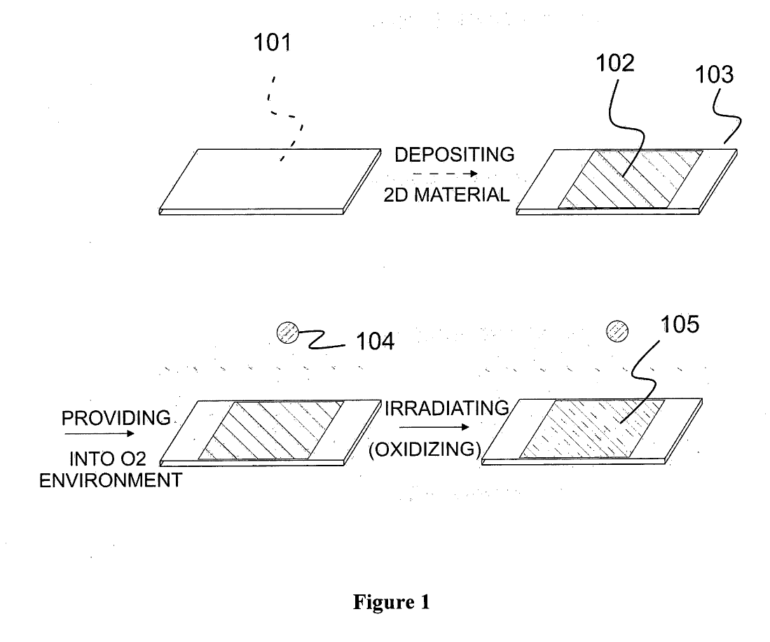

Exemplary embodiments of the present invention and its potential advantages are understood by referring to FIGS. 1 through 5 of the drawings.

Conventional thermal oxidation of 2D objects comprising TMDs and III-V materials can be challenging due to the costs and complexity, as well as high temperature which may be destructive for plastic substrates and thin films; while plasma-induced oxidation is hardly scalable due to very slow process and lack of uniformity. A fast and efficient oxidation of III-V materials and TMDs which would be compatible with low-temperature and high-throughput roll-to-roll processes is desirable. In one embodiment of the present invention, a new technique for photo-thermal oxidation of 2D III-V materials and 2D TMD materials is disclosed. The oxidation takes place upon exposure to photonic irradiation (for example, by pulsed xenon light) in an environment comprising Oxygen. In an embodiment, the oxidation may take place at ambient conditions.

For the purposes of this specification, two-dimensional objects such as 2D films, 2D single crystals, 2D flakes etc. are provided for exemplary purposes only. In these examples, the materials used are also substantially two-dimensional for exemplary purposes.

FIG. 1 shows an exemplary embodiment of the present invention. Normal lines show required steps of the method according to this embodiment, while optional steps and positions are shown by dashed lines. As a first optional step, a substrate 101 can be provided. The substrate may be e.g. a low melting temperature plastic substrate or a rigid glass substrate. A material 102 is then optionally deposited onto the substrate, forming a 2D object 103. The material 102 comprises a TMD group material and/or a III-V group material. It may be deposited, for example, by spray coating, spin-coating, drop-coating, thin film transfer or inkjet printing. The thickness (i.e. the smallest dimension) of the deposited material may vary between 1 nanometer and 1 micrometer. A TMD group material may be, for example, Molybdenum sulfide (MoS₂), Molybdenum diselenide (MoSe₂), Tungsten sulfide (WS₂), Tungsten diselenide (WSe₂), Niobium sulfide (NbS₂), Vanadium sulfide (VS₂,), or Tantalum sulfide (TaS₂), or a combination thereof. A III-V group material may be, for example, Boron nitride (BN), Boron carbon nitride (BCN), Aluminium nitride (AlN), Gallium nitride (GaN), Indium Nitride (InN), Indium phosphide (InP), Indium arsenide (InAs), Boron phosphide (BP), Boron arsenide (BAs), or Gallium phosphide (GaP), or a combination thereof.

The 2D object 103 is then provided into an environment comprising Oxygen. The environment may be, for example, air at ambient conditions, oxygen, oxygen mixed with the inert gas or ozone.

In the environment comprising Oxygen, at least one part of the 2D object is exposed to photonic irradiation. A source of photonic irradiation 104 is schematically shown as a circle on FIG. 1; however, a skilled person would assume that the source 104 may be of any shape or form. A xenon flash lamp may be used as a source of photonic irradiation 104 to irradiate the object 103 for a predetermined amount of time. The wavelength of the photonic irradiation may be between 200 nm and 900 nm. The materials used absorb the light in Ultraviolet-visible (UV-vis) region, which is well matched with a xenon flash lamp emission spectrum. The xenon flash lamp or another source of irradiation may be positioned above the substrate, or in any other suitable position at a predetermined distance. The flash lamp power may vary from 100 to 3000 Watts. If pulsed photonic irradiation is used, the pulse frequency may be from 1 to 300 Hertz. The individual pulse duration may be in the range from 10 microseconds to 5 milliseconds. The overall exposure time may vary from 1 second to 60 minutes. A photomask may be applied to the 2D object prior to the photonic irradiation. Alternatively, a photomask may be used at a distance from the 2D object during the irradiation. Using the photomask allows selective exposure of at least one part of the 2D object that is not covered by the photomask to photonic irradiation.

The photonic irradiation oxidizes at least part of the material 102 of the exposed part of the 2D object 103. In other words, if a part of the 2D object 103 exposed to irradiation comprises a III-V group material or a TMD group material, at least part of this material will be oxidized by the irradiation. The resulting partially or fully oxidized material is indicated by position 105 on FIG. 1. In case of partial oxidation, multiple layers along the thickness of the resulting material 105 may be produced. For example, a top layer may be oxidized, while the bottom layer may remain unoxidized, which creates a “vertical oxidation pattern” in the material, i.e. a pattern of different levels of oxidations along the thickness of the material. Intermediate oxidation may also occur in one or more layers of the resulting material 105. If a photomask is used, areas or parts of the material film that are not covered by the photomask are oxidized. This can create a “horizontal oxidation pattern” in the material, i.e. a pattern of different levels of oxidations along the greater dimensions (width and length) of the material. The resulting object may be nearly transparent.

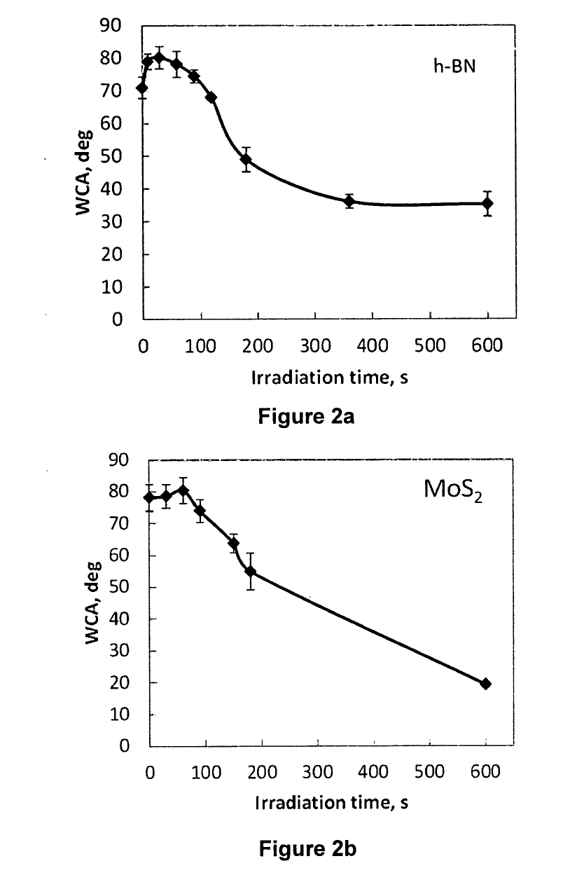

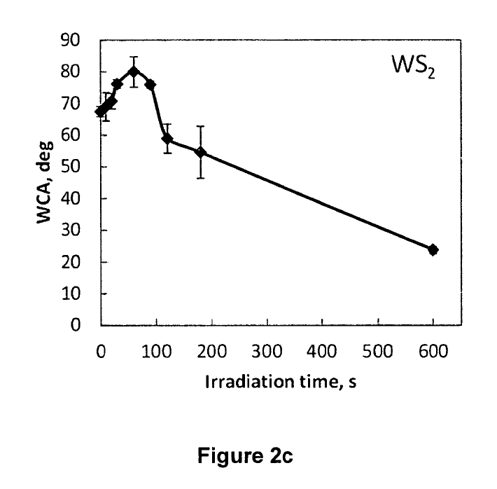

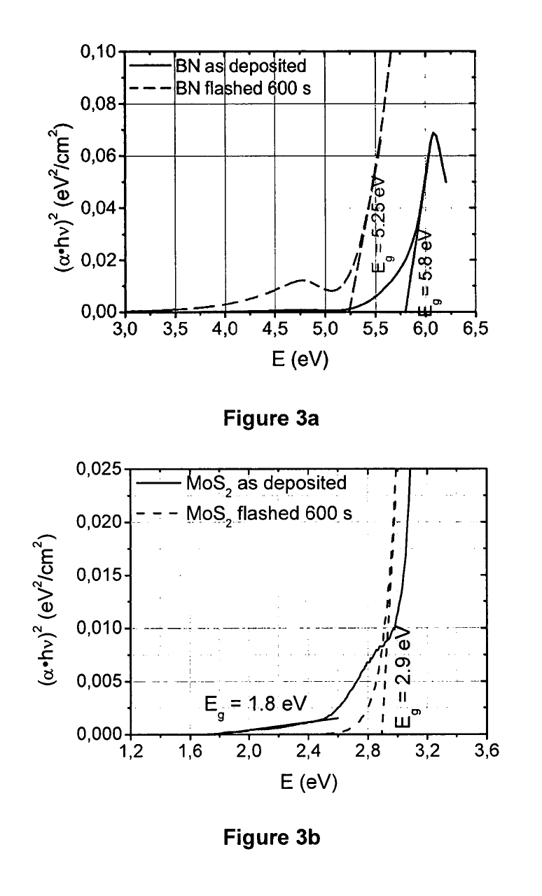

The oxidation of material can be used to create surface wettability contrast in the material, to tune the bandgap of the material and for various other purposes. Examples of such applications of the method according to the present invention are described with reference to FIGS. 2-3. The resulting 2D objects with fully or partially oxidized material 105 can be used in photoluminescence, photochromics devices, solar cells, lasers, heterotransistors, Schottky diodes, photocatalysis, Field Effect Transistors; low-work and high-work function transparent electrodes in transistors, OLEDs, solar cells; chemical and gas sensors and various other applications.

The methods according to the present invention are easy to scale up and use e.g. in mass production; the invention does not rely on the use of a mask; use of any chemicals which result in hazardous waste is not necessary; and compatibility with low-melting-point substrates, flexible substrates and Roll-to-Roll manufacture is possible.

For better understanding of the mechanisms underlying embodiments of the present invention in more detail, an example of the oxidation process for two-dimensional hexagonal Boron Nitride (2D h-BN) can be provided. Photothermally induced oxidation of 2D h-BN is most likely to occur through breaking the B—N bonds and substitution of nitrogen atoms in the B—N plane by O atoms. The formation of epoxide groups on the surface is also possible. In the case of TMD materials, the photonic oxidation causes the substitution of chalcogen atoms by oxygen atoms aligned with the metal valence change from four to higher values. In case of exemplary TMD materials such as 2D MoS₂ and WS₂, oxidation using a xenon flash lamp in the presence of oxygen is also performed. It has been observed by the inventors that the 2D MoS₂ thin film oxidizes more readily than the WS₂ thin film. The resulting oxides MoOₓ and WOₓ have been obtained most likely through the step of formation of sub-oxides MoSₓO_{y} and WSₓO_{y}. Due to the fact that the xenon flash irradiation induces a local heat generation in the 2D thin films, the flash oxidation is considered to be a substantially thermal process. Thus, photothermal flash oxidation in the presence of oxygen from the air leads to the formation of oxygen groups on the surface of 2D layered materials.

In general, the abovementioned 2D materials appear to be more reactive than bulk materials due to a larger surface area and defects at the edge of flakes which cause electron/hole accumulation. That is one of the reasons why 2D thin films can be oxidized relatively quickly while the bulk materials are usually more stable. The morphology of 2D thin films changes with irradiation time most likely because of restructuring and rapid degassing which leads to exfoliated and disorderly packed 2D flakes. When oxidizing a 2D single crystal, the light intensity possibly needs to be controlled in order to prevent the etching of the layer.

One possible implementation of embodiments of the present invention is control of surface wettability of the materials and consequently 2D objects. This is exemplified by the 2D hexagonal Boron Nitride (h-BN) for the III-V group materials and by 2D MoS₂ and WS₂ for TDM group materials, illustrated through FIGS. 2a-2c. As it is clear to a skilled person, this implementation is suitable for any other material of these groups.

In case of 2D h-BN, the surface wettability can be effectively controlled by creating a combination of hydrophilic BNO regions and relatively hydrophobic h-BN regions using selective oxidation by photonic irradiation with a photomask. “Hydrophilic” material refers to a solid polar material that naturally has an affinity for water. “Hydrophobic” material is a solid non-polar substance with relatively low surface free energy, which naturally repels water. As a result of oxidation, the water contact angle (WCA) of the material becomes lower, showing an increase in surface energy—this is demonstrated by the graph of WCA against irradiation time in seconds on FIG. 2a. The polar component of the surface energy increases during oxidation.

In case of 2D MoS₂ and WS₂, the water contact angle evolution with irradiation time is shown on FIGS. 2b and 2c. A wettability contrast approaching 60° can be obtained by oxidation of MoS₂ to MoOₓ and WS₂ to WOₓ, which is a significant contrast that may have different applications. The surface energy increases from approximately 32.2 to 69.5 mN/m for MoS₂ and from approximately 35.8 to 68.6 mN/m for WS₂, with the polar component of the surface energy increasing predominantly.

Using a mask in this implementation can result in a pattern with high surface energy contrast, which can be utilized advantageously for improved inkjet printing or advanced microfluidics.

Another possible implementation of embodiments of the present invention is tuning an electronic property of 2D materials by changing the bandgap width by oxidation via photonic irradiation. This is exemplified by the 2D h-BN for the III-V group materials and by 2D MoS₂ for TDM group materials, illustrated through FIGS. 3a and 3b. As it is clear to a skilled person, this implementation is suitable for any other material of these groups.

The bandgap of the 2D BNO material decreases from 5.80 to 5.25 eV with increase in oxygen composition, leading to a change of the electrical conductivity. FIG. 3a is a graph of the square of the production absorption coefficient and photon energy against photon energy, illustrating the change in the bandgap of the material. BN and BNO are insulators, which can be advantageous for example when using the material as a heat spreader in direct contact with high-power density semiconductor nanodevices.

The bandgap of oxidized MoS₂ (2.90 eV) appeared to be close to that of bulk MoO₃ (2.7-3.0 eV) and the bandgap of oxidized WS₂ (2.85 eV) is also similar to that of bulk WO₃ (2.8-3.1 eV). In contrast, pristine 2D MoS₂ and WS₂ have 1.5-1.9 eV and 1.3-1.8 eV bandgap, respectively. This increase can be seen on FIG. 3b which is a graph similar to FIG. 3a but for the TMD material MoS₂, and the behavior is similar for WS₂ (not illustrated).

Tunable bandgap between 1 and 3 eV can be advantageous in photoluminescence, photochromic devices, solar cells, optical devices and for various other applications.

According to an aspect of the present invention, a device for oxidation of two-dimensional materials is disclosed. The device is configured to provide an environment comprising oxygen in the reactor, i.e. create conditions in the reactor suitable for the oxidation; hold a two-dimensional object comprising a III-V group material and/or a Transition Metal Dichalcogenides (TMD) group material inside the reactor; expose at least one part of the two-dimensional object to photonic irradiation of the flash lamp in the reactor; and oxidize at least part of the material in the exposed at least one part of the two-dimensional object.

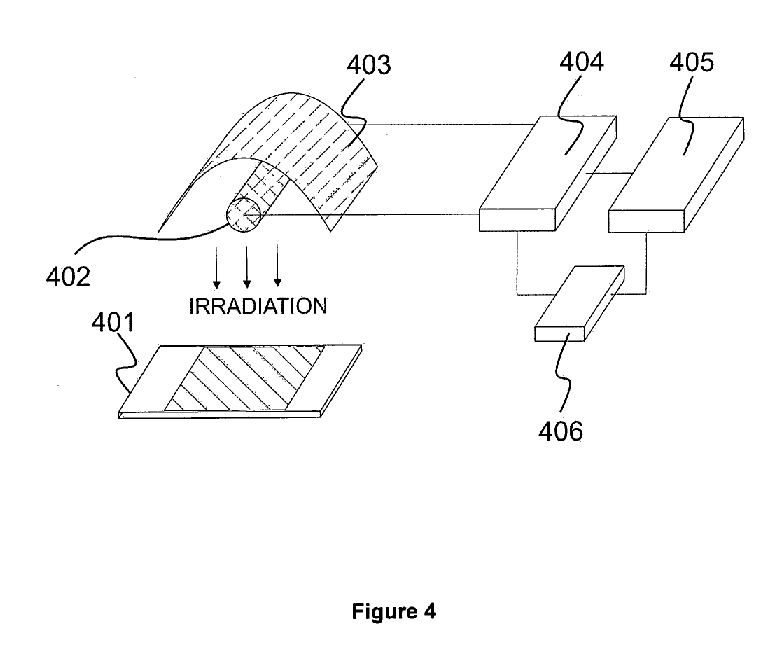

FIG. 4 is a schematic illustration of the device according to an embodiment of the present invention. The illustrated embodiment includes a two-dimensional object 401 comprising a III-V group material or a TMD group material to be oxidized by the device. The device may comprise a substrate holder. The 2D object 401 may be stationary relative to the device, or the 2D object 401 may be conveyed relative to the device, for example between rolls in a roll-to-roll process. The device may include a lamp, such as a xenon flash lamp 402, which may have an emission spectrum ranging from 200 nanometers to 900 nanometers. The lamp 402 may be selected based on the absorption spectrum of the material. The lamp 402 may be partially surrounded by a reflector 403 which may be elliptical or parabolic in shape and which may serve to direct the emitted irradiation of the lamp 402 toward the 2D object 401. The lamp 402 may be driven by a discharge module 404 which may be configured to provide the necessary electrical power to the lamp 402 at a predetermined frequency and duration. The device may further comprise a power supply 405 to provide power to the discharge module 404, and a controller 406 which controls the frequency, pulse duration and irradiation time of the lamp 402 by controlling the discharge module 404.

The device may further include a mask disposed between the flash lamp and the substrate, the mask serving to obstruct or block at least a portion of irradiation from the flash lamp 402 to the 2D object 401.

Without in any way limiting the scope, interpretation, or application of the claims appearing below, a technical effect of one or more of the example embodiments disclosed herein is compatibility with flexible and/or low-melting-temperature substrates and Roll-to-Roll manufacturing. Another technical effect of one or more of the example embodiments disclosed herein is clean production of 2D objects comprising oxidized materials without the output of chemical waste. Another technical effect of one or more of the example embodiments disclosed herein is that Xenon flash method can be easily coupled to mass production in a printing method for the III-V and TMD materials and their derivatives. The wettability and bandgap may be tailored in situ for the described processes.

Among the various technical application of one or more of the example embodiments disclosed herein, production of the following structures can be mentioned: TMO-TMD heterojunctions which can be utilized in heterotransistors, Schottky diodes, photocatalysis; High-k TMO dielectrics to be used in Field Effect Transistors; Conductive TMO low-work and high-work function transparent electrodes for transistors, OLEDs, solar cells; TMO-TMD based chemical and gas sensors.

An apparatus in accordance with the invention may include at least one processor in communication with a memory or memories. The processor may be configured to store, control, add and/or read information from the memory. The memory may comprise one or more computer programs which can be executed by the processor. The processor may also be configured to control the functioning of the apparatus. The processor may be configured to control other elements of the apparatus by effecting control signaling. The processor may, for example, be embodied as various means including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC), or field programmable gate array (FPGA), or some combination thereof. Signals sent and received by the processor may include any number of different wireline or wireless networking techniques.

The memory can include, for example, volatile memory, non-volatile memory, and/or the like. For example, volatile memory may include Random Access Memory (RAM), including dynamic and/or static RAM, on-chip or off-chip cache memory, and/or the like. Non-volatile memory, which may be embedded and/or removable, may include, for example, read-only memory, flash memory, magnetic storage devices, for example, hard disks, floppy disk drives, magnetic tape, etc., optical disc drives and/or media, non-volatile random access memory (NVRAM), and/or the like.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-20. (canceled)

21. A method, comprising:
providing a two-dimensional object comprising a III-V group material and/or a Transition Metal Dichalcogenides (TMD) group material into an environment comprising oxygen; and
exposing at least one part of the two-dimensional object to photonic irradiation in said environment, thereby oxidizing at least part of the material of the exposed part of the two-dimensional object.

22. The method of claim 21, further comprising:
providing a substrate, and
prior to providing the two-dimensional object into an environment comprising oxygen, depositing the III-V group material and/or the TMD group material onto the substrate, thereby forming the two-dimensional object comprising the III-V group material and/or the Transition Metal Dichalcogenides (TMD) group material.

23. The method of claim 22, wherein depositing the III-V group material and/or the TMD group material onto the substrate is performed by at least one of the following techniques: spray coating, spin-coating, drop-coating, thin film transfer and inkjet printing.

24. The method of claim 22, wherein the substrate comprises a plastic substrate.

25. The method of claim 22, wherein the substrate comprises a rigid glass substrate.

26. The method of claim 21, wherein the III-V group material comprises at least one of: Boron nitride (BN), Boron carbon nitride (BCN), Aluminium nitride (AlN), Gallium nitride (GaN), Indium Nitride (InN), Indium phosphide (InP), Indium arsenide (InAs), Boron phosphide (BP), Boron arsenide (BAs), and Gallium phosphide (GaP).

27. The method of claim 21, wherein the TMD group material comprises at least one of: Molybdenum sulfide (MoS₂), Molybdenum diselenide (MoSe₂), Tungsten sulfide (WS₂), Tungsten diselenide (WSe₂), Niobium sulfide (NbS₂), Vanadium sulfide (VS_{2,}), and Tantalum sulfide (TaS₂).

28. The method of claim 21, wherein the photonic irradiation comprises a wavelength spectrum between 200 nanometers to 900 nanometers by a xenon flash lamp.

29. The method of claim 21, wherein exposing at least one part of the two-dimensional object to photonic irradiation comprises exposing the at least one part of the two-dimensional object to pulsed photonic irradiation.

30. The method of claim 29, wherein an individual pulse duration of the pulsed photonic irradiation is between 10 microseconds and 5 milliseconds, with a pulse frequency between 1 Hertz and 300 Hertz.

31. The method of claim 21, wherein exposing at least one part of the two-dimensional object to photonic irradiation is performed for a period of time between 1 second and 60 minutes.

32. The method of claim 21, wherein exposing at least one part of the two-dimensional object to photonic irradiation comprises exposing the at least one part of the two-dimensional object to photonic irradiation using a photomask.

33. The method of claim 32, wherein exposing at least one part of the two-dimensional object to photonic irradiation using a photomask comprises selectively exposing to photonic irradiation at least one part of the two-dimensional object that is not covered by the photomask, thereby oxidizing at least part of the material of the two-dimensional object not covered by the photomask.

34. The method of claim 22, wherein exposing at least one part of the two-dimensional object to photonic irradiation comprises exposing the at least one part of the two-dimensional object to photonic irradiation from a source that is positioned, at a predetermined distance, on the side of the substrate on which the III-V group material and/or the TMD group material was deposited.

35. A device comprising:
a reactor and
a flash lamp, wherein the reactor comprises an environment comprising oxygen, and wherein the device further comprises:
a space at least partially inside the environment for receiving a two-dimensional object comprising a III-V group material and/or a Transition Metal Dichalcogenides (TMD) group material,
wherein the flash lamp is caused to irradiate at least one part of the two-dimensional object when the two-dimensional object is in the space, thus causing oxidation of at least part of the material in the irradiated part of the two-dimensional object.

36. The device of claim 35, further comprising a reflector for directing the photonic irradiation of the flash lamp toward the two-dimensional object.

37. The device of claim 35, further comprising a discharge module for providing electrical power to the flash lamp at a predetermined frequency and duration.

38. The device of claim 35, wherein the flash lamp is a xenon flash lamp with an emission spectrum between 200 nanometers and 900 nanometers, and wherein the flash lamp is caused to irradiate at least one part of the two-dimensional object in pulses.

39. The device of claim 38, wherein individual pulse duration is between 10 microseconds and 5 milliseconds and a pulse frequency is between 1 Hertz and 300 Hertz.

40. An apparatus comprising
at least one processor;
at least one memory coupled to the at least one processor, the at least one memory comprising program code instructions which, when executed by the at least one processor, cause the apparatus to:
provide a two-dimensional object comprising a III-V group material and/or a Transition Metal Dichalcogenides (TMD) group material into an environment comprising oxygen; and
expose at least one part of the two-dimensional object to photonic irradiation in said environment, thereby oxidizing at least part of the material of the exposed part of the two-dimensional object.
